(19) United States
(12) Patent Application Publication
(10) Pub. No.: US 2018/0016915 A1
(43) Pub. Date: Jan. 18, 2018

(54) TURBOMACHINE COMPONENT HAVING A PLATFORM CAVITY WITH A STRESS REDUCTION FEATURE

(71) Applicant: Siemens Aktiengesellschaft, Munich (DE)

(72) Inventors: Mark Osborne, Harmston (GB); Martin Williams, Dunston (GB)

(73) Assignee: Siemens Aktiengesellschaft, Munich (DE)

(21) Appl. No.: 15/647,342

(22) Filed: Jul. 12, 2017

(30) Foreign Application Priority Data
Jul. 18, 2016 (EP) 16179851.7

(51) Int. Cl. F01D 5/18; F01D 9/04; F01D 25/12

(52) U.S. Cl. CPC F01D 5/18; F01D 25/12; F01D 9/041; F05D 2250/14; F05D 2240/304; F05D 2240/122; F05D 2220/32; F05D 2250/70; F05D 2260/20; F05D 2240/128

(57) ABSTRACT

A turbomachine component having an aerofoil, such as a blade or a vane for a gas turbine engine, includes a suction side wall and a pressure side wall bordering an aerofoil cavity, and meeting at a leading edge and a trailing edge. The turbomachine component also includes a circumferentially extending first platform wherefrom the aerofoil extends radially. The first platform includes a first-platform cavity corresponding to a shape of the aerofoil and continuous with the aerofoil cavity. The first-platform cavity has a leading-edge end and a trailing-edge end corresponding to the leading edge and the trailing edge, respectively, of the aerofoil. The first-platform cavity at the trailing-edge end forms a protuberance within the first platform. The turbomachine component may optionally include a second-platform cavity in a circumferentially extending second platform. The second-platform cavity at its trailing-edge end forms an additional protuberance within the second platform.

### CROSS REFERENCE TO RELATED APPLICATIONS

This application claims the benefit of European Application No. EP16179851 filed Jul. 18, 2016, incorporated by reference herein in its entirety.

### FIELD OF INVENTION

The present invention relates to turbomachine components, and more particularly to turbomachine components having aerofoils for example a turbine vane for a gas turbine.

### BACKGROUND OF INVENTION

In turbomachine components having an aerofoil, such as turbine vanes or blades, aerofoil structures are essential. In some turbomachine components having the aerofoils, in particular a turbine vane, usually the aerofoil extends between an inner platform and an outer platform. The inner platform of the turbine vane, hereinafter also referred to as the vane, is the platform which is positioned towards the rotational axis or the rotational shaft of the turbine whereas the outer platform of the vane is the platform which is positioned towards an external casing of the turbine, i.e. in the radial direction with respect to the rotational axis of the turbine, first comes the inner platform then the aerofoil and thereafter the outer platform of the vane and then the external casing of the turbine. In some other turbomachine components having the aerofoils, in particular a turbine blade, hereinafter also referred to as the blade, the aerofoil extends from one platform, similar to the inner platform, and is free at the other end. The platform in the blade is arranged towards the rotational axis of the turbine, i.e. in the radial direction with respect to the rotational axis of the turbine, first comes the platform then the aerofoil, thereafter the free end of the blade and then the external casing of the turbine.

Hereinafter, for the purposes of the present disclosure turbine vane has been used as an example for a turbomachine component having an aerofoil but as may be appreciated by one skilled in the art of turbomachines, the turbomachine component having the aerofoil also includes turbine blades and the present technique is implemented in turbine blades and/or turbine vanes in a gas turbine.

FIG. 2 schematically represents a conventionally known turbomachine component having an aerofoil for example a turbine vane 200, and FIG. 3 schematically represents the turbine vane 200 of FIG. 2 in a direction represented by arrow marked A in FIG. 2. As depicted in FIGS. 2 and 3, the vane 200 has an aerofoil 210. The aerofoil 210 is formed of a pressure side wall 214 and a suction side wall 216 that meet at a leading edge 218 and a trailing edge 220, as is conventionally known. The trailing edge 220 is usually a narrow bent and has a sharper turn, or in other words a tighter radius, as compared to the leading edge 218. The side walls 214 and 216 enclose an aerofoil cavity (not shown in FIGS. 2 and 3). The aerofoil 210 extends between an inner platform 230, i.e. the platform which is arranged closer to rotational axis or a main shaft of the turbine when the turbine vane 200 is in its operational position within the turbine, and an outer platform 240 that is arranged away in a radial direction from the rotational axis with respect to the inner platform 230.

The inner platform 230 has an aerofoil-side surface 232, and a shaft-side surface 234. The outer platform 240 has an aerofoil-side surface 242, and a casing-side surface 244. The aerofoil 210 has an inner end region 217 and an outer end region 219. The terms “inner” and “outer,” as used herein, are intended to mean relative to the rotational axis (not shown in FIGS. 2 and 3) of the turbine when the vane 200 is installed in its operational position. The side walls 214 and 216 of the aerofoil 210 emanate from or are contiguous with the aerofoil-side surfaces 232, 242. The airfoil 210 along with the inner platform 230 and/or the outer platform 240 is conventionally formed as a unitary structure, for example, by casting or forging. A fillet 231 is positioned between the aerofoil 210 and the aerofoil-side surface 232 of the inner platform 230 where the aerofoil 210 emerges from the aerofoil-side surface 232 of the inner platform 230 as depicted in FIG. 2. Similarly, a fillet 241 is positioned between the aerofoil 210 and the aerofoil-side surface 242 of the outer platform 240 where the aerofoil 210 emerges from the aerofoil-side surface 242 of the outer platform 240 as depicted in FIG. 3.

A gas path, i.e. a path for flow of hot gases coming from the combustor section (not shown in FIGS. 2 and 3) in the gas turbine, with reference to the turbine vane 200 is limited by the aerofoil-side surface 232 and the aerofoil-side surface 242 and around the pressure side 214 and the suction side 216 and generally in direction from the leading edge 218 towards the trailing edge 220. In other words, the aerofoil-side surface 232, the aerofoil-side surface 242, the pressure side 214, the suction side 216, the leading edge 218 and the trailing edge 220 are directly exposed to the hot combustion gases when the turbine is in operation.

Referring now to FIGS. 4 and 5, in combination with FIGS. 2 and 3, one or both of the inner platform 230, as shown in FIG. 3, and the outer platform 240, as shown in FIG. 2, include a platform cavity for example an inner platform cavity 235 and/or an outer platform cavity 245 which extends within its respective platforms 230, 240. As shown in FIG. 2 the outer platform cavity 245 is limited by an outer platform cavity wall 246 and as shown in FIG. 3 the inner platform cavity 235 is limited by an inner platform cavity wall 236. One or both, when present, of the platform cavities 235, 245 are contiguous with the aerofoil cavity and are substantially similar in shape to a shape of the aerofoil 210. As shown in FIGS. 4 and 5, the inner platform cavity 235 has a trailing-edge end 252, a leading-edge end 258, and side walls 254, 256, and similarly the outer platform cavity 245 has a trailing-edge end 262, a leading-edge end 268, and side walls 264, 266.

The trailing edge 220, and thus the trailing-edge ends 252, 262 are usually narrow bents and have a sharp turn, or in other words a tight radius, as compared to the leading-edge end 258,268 as shown in FIGS. 4 and 5. The breakout in the platform wherefrom the trailing edge 220 of the aerofoil 210 emerges, i.e. region 237,247 of the platform 230, 240 in and around the junction where the trailing edge 220 of the aerofoil 210 meets the platform 230,240 is subjected to various disadvantages due to the narrow shape of the trailing edge joint to the platform i.e. due to the narrow bent of the trailing-edge end 252,262. The breakouts are at the inner platform 230 and/or the outer platform 240 for the vanes 200, and at the platform for the blade. Some of the disadvantages are outlined hereinafter.

During casting of the turbomachine component 200 having the aerofoil 210, when the cast material is undergoing solidification to form the cast component a narrow radium or smaller radius at the trailing edge and platform junction, at the curved portion of the cavity 235,245 i.e. the trailing-edge end 252,256 has hoop stress that gets introduced during the casting solidification process. The hoop stress is released thorough the part of the cavity with narrowest or smallest radius i.e. the trailing-edge end 252,262 and thus probability of development and propagation of cracks is high within the platforms 230, 240. Crack propagation will mean a failed casting and the process of casting has to be repeated.

Also, in post casting drilling process through the fillet 231, 241 i.e. a roughly triangular strip of material which rounds off an interior angle between the aerofoil surface and the platform surface 232, 242 to which the aerofoil 210 is connected, may be problematic due to tight spacing of the trailing-edge end 252,262 as shown in FIGS. 4 and 5, drill size is comparable to the trailing-edge end 252,262 and thus the drilling tip which is intended to drill through the fillet 231,241 and then through the trailing-edge end 252,262 in the platforms 230,240 may completely miss the cavity or may misplace the hole thereby placing the hole at a position other than the tip of the trailing-edge end 252,262.

During post casting manufacturing processes, the platform cavity 235,245 of the platform 230,240 is provided with additional components (not shown in FIGS. 2 to 5) such as a tube for circulation of a coolant for example an impingement cooling tube. The closer the impingement cooling tube is positioned to the platform i.e. walls 236,246 of the platform cavity 235,245 in the platform 230,240, extending from within the platform cavity 235,245, the better it cools the portion of the platform 230,240 adjacent to the platform cavity 235,245. However, since the space of the platform cavity 235, 245 at the trailing-edge end 252,262 has a very small radius owing to the narrow bent of the trailing-edge end 252,262 at the breakout, the extent to which the cooling tube can be positioned closer to the platform wall 236,246 within the trailing-edge end 252, 262 is restricted.

Furthermore, during operation of the turbine, the load on the trailing edge 220 is high, and thus on the trailing-edge end 252,262 and smaller the radius more is the stress concentration in the breakout region 237, 247, which leads to failure for example cracking in the platform 230, 240 in the tailing-edge end 252, 262.

### SUMMARY OF INVENTION

Thus an object of the present disclosure is to provide a feature to the trailing-edge end 252,262 of the platform 230, 240 with which the above mentioned disadvantages are at obviated or reduced.

The above objects are achieved by turbomachine component having an aerofoil, and an array of turbomachine components, of the present technique. Advantageous embodiments of the present technique are provided in dependent claims. Features of the independent claims may be combined with features of claims dependent on them respectively, and features of dependent claims can be combined together.

In an aspect of the present technique, a turbomachine component having an aerofoil, particularly a blade or a vane for a gas turbine engine, is presented. The turbomachine component includes a suction side wall of the aerofoil and a pressure side wall of the aerofoil. The suction side wall and the pressure side wall together border an aerofoil cavity. The suction side wall and the pressure side wall meet at a leading edge and a trailing edge. The turbomachine component also includes a circumferentially extending first platform wherefrom the aerofoil extends radially. The first platform includes a first-platform cavity corresponding to a shape of the aerofoil. The first-platform cavity is continuous with the aerofoil cavity. The first-platform cavity has a leading-edge end corresponding to the leading edge of the aerofoil and a trailing-edge end corresponding to the trailing edge of the aerofoil. The first-platform cavity at the trailing-edge end forms a protuberance within the first platform.

The protuberance at the trailing-edge end of the first-platform cavity makes the radium of the curve at the trailing-edge end larger or in other words the bent at the trailing-edge end is wider and thus the stress is distributed in a wider area of the first platform around the trailing-edge end and not concentrated at a narrow shaped trailing edge as present in conventionally known vanes or blades. Furthermore, the in post casting drilling process through the fillet the chances of the drill head missing the trailing-edge end or misplacing the hole around the trailing-edge end are also reduced because of the wider trailing-edge end owing to the protuberance. During operation of the turbine the load where trailing edge of the aerofoil joins the platform i.e. at the trailing-edge end is also distributed over a wider area due to the protuberance. Also, the protuberance provides more space to position cooling fluid tubes close to the platform cavity wall thereby facilitating efficient cooling.

In an embodiment of the present technique, the turbomachine component further includes a circumferentially extending second platform. The aerofoil radially extending from the first platform radially extends into the second platform. The second platform includes a second-platform cavity corresponding to the shape of the aerofoil. The second-platform cavity is continuous with the aerofoil cavity. The second-platform cavity has a leading-edge end corresponding to the leading edge of the aerofoil and a trailing-edge end corresponding to the trailing edge of the aerofoil. The second-platform cavity at the trailing-edge end forms an additional protuberance within the second platform. The additional protuberance within the second platform means that in turbomachine components such as vane both the inner and the outer platform have the advantages as described hereinabove in reference to the protuberance in the first platform.

In another aspect of the present technique, an array of turbomachine components is presented. The array includes a plurality of turbomachine components arranged contiguously. At least one of the turbomachine components in the array is according to the aspect of the technique presented hereinabove. Thus the array for example a vane assembly forming a circular stage of gas turbine has same advantages as described hereinabove in reference to the protuberance in the first platform and the additional protuberance in the second platform.

### BRIEF DESCRIPTION OF THE DRAWINGS

The above mentioned attributes and other features and advantages of the present technique and the manner of attaining them will become more apparent and the present technique itself will be better understood by reference to the following description of embodiments of the present technique taken in conjunction with the accompanying drawings, wherein:

FIG. 1 shows part of a turbine engine in a sectional view and in which a turbomachine component of the present technique is incorporated;

FIG. 2 schematically illustrates a conventionally known turbine vane;

FIG. 3 schematically illustrates another view of the conventionally known turbine vane presented in FIG. 2;

FIG. 4 schematically illustrates a cross-section of an inner or an outer platform of the conventionally known turbine vane presented in FIGS. 2 and 3;

FIG. 5 schematically illustrates another embodiment of the cross-section of the inner or the outer platform of the conventionally known turbine vane presented in FIGS. 2 and 3;

FIG. 6 schematically illustrates an exemplary embodiment of a turbomachine component of the present technique;

FIG. 7 schematically illustrates another view of the turbomachine component of FIG. 6 according to the present technique;

FIG. 8 schematically illustrates a cross-section of an exemplary embodiment of a first and/or a second platform of the turbomachine component of the present technique presented in FIGS. 6 and 7;

FIG. 9 schematically illustrates a cross-section of another exemplary embodiment the first and/or the second platform of the turbomachine component of the present technique presented in FIGS. 6 and 7;

FIG. 10 schematically illustrates an exemplary embodiment of a protuberance with a cooling fluid tube arranged within the protuberance of the turbomachine component of the present technique;

FIG. 11 schematically illustrates another exemplary embodiment of the protuberance with a cooling fluid tube arranged within the protuberance of the turbomachine component of the present technique; and

FIG. 12 schematically illustrates an exemplary embodiment of an array of turbomachine components; in accordance with aspects of the present technique.

### DETAILED DESCRIPTION OF INVENTION

Hereinafter, above-mentioned and other features of the present technique are described in details. Various embodiments are described with reference to the drawing, wherein like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the invention. It may be evident that such embodiments may be practiced without these specific details.

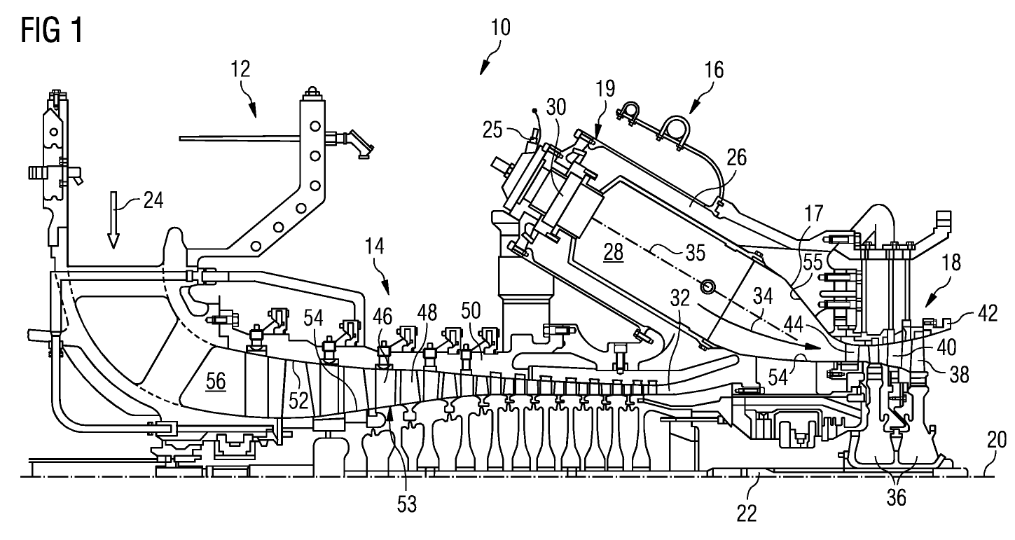

FIG. 1 shows an example of a gas turbine engine 10 in a sectional view. The gas turbine engine 10 comprises, in flow series, an inlet 12, a compressor or compressor section 14, a combustor section 16 and a turbine section 18 which are generally arranged in flow series and generally about and in the direction of a longitudinal or rotational axis 20. The gas turbine engine 10 further comprises a shaft 22 which is rotatable about the rotational axis 20 and which extends longitudinally through the gas turbine engine 10. The shaft 22 drivingly connects the turbine section 18 to the compressor section 14.

In operation of the gas turbine engine 10, air 24, which is taken in through the air inlet 12 is compressed by the compressor section 14 and delivered to the combustion section or burner section 16. The burner section 16 comprises a burner plenum 26, one or more combustion chambers 28 and at least one burner 30 fixed to each combustion chamber 28. The combustion chambers 28 and the burners 30 are located inside the burner plenum 26. The compressed air passing through the compressor 14 enters a diffuser 32 and is discharged from the diffuser 32 into the burner plenum 26 from where a portion of the air enters the burner 30 and is mixed with a gaseous or liquid fuel. The air/fuel mixture is then burned and the combustion gas 34 or working gas from the combustion is channeled through the combustion chamber 28 to the turbine section 18 via a transition duct 17.

This exemplary gas turbine engine 10 has a cannular combustor section arrangement 16, which is constituted by an annular array of combustor cans 19 each having the burner 30 and the combustion chamber 28, the transition duct 17 has a generally circular inlet that interfaces with the combustor chamber 28 and an outlet in the form of an annular segment. An annular array of transition duct outlets form an annulus for channeling the combustion gases to the turbine 18.

The turbine section 18 comprises a number of blade carrying discs 36 attached to the shaft 22. In the present example, two discs 36 each carry an annular array of turbine blades 38. However, the number of blade carrying discs could be different, i.e. only one disc or more than two discs. In addition, guiding vanes 40, which are fixed to a stator 42 of the gas turbine engine 10, are disposed between the stages of annular arrays of turbine blades 38. Between the exit of the combustion chamber 28 and the leading turbine blades 38 inlet guiding vanes 44 are provided and turn the flow of working gas onto the turbine blades 38. The turbomachine component (not shown in FIG. 1) of the present technique may be, but not limited to, the turbine blades 38, the guiding vanes 40.

The combustion gas from the combustion chamber 28 enters the turbine section 18 and drives the turbine blades 38 which in turn rotate the shaft 22. The guiding vanes 40, 44 serve to optimise the angle of the combustion or working gas on the turbine blades 38.

The turbine section 18 drives the compressor section 14. The compressor section 14 comprises an axial series of vane stages 46 and rotor blade stages 48. The rotor blade stages 48 comprise a rotor disc supporting an annular array of blades. The compressor section 14 also comprises a casing 50 that surrounds the rotor stages and supports the vane stages 48. The guide vane stages include an annular array of radially extending vanes that are mounted to the casing 50. The vanes are provided to present gas flow at an optimal angle for the blades at a given engine operational point. Some of the guide vane stages have variable vanes, where the angle of the vanes, about their own longitudinal axis, can be adjusted for angle according to air flow characteristics that can occur at different engine operations conditions. The casing 50 defines a radially outer surface 52 of the passage 56 of the compressor 14. A radially inner surface 54 of the passage 56 is at least partly defined by a rotor drum 53 of the rotor which is partly defined by the annular array of blades 48.

The present technique is described with reference to the above exemplary turbine engine having a single shaft or spool connecting a single, multi-stage compressor and a single, one or more stage turbine. However, it should be appreciated that the present technique is equally applicable to two or three shaft engines and which can be used for industrial, aero or marine applications.

The terms upstream and downstream refer to the flow direction of the airflow and/or working gas flow through the engine unless otherwise stated. The terms forward and rearward refer to the general flow of gas through the engine. The terms axial, radial and circumferential are made with reference to the rotational axis 20 of the engine.

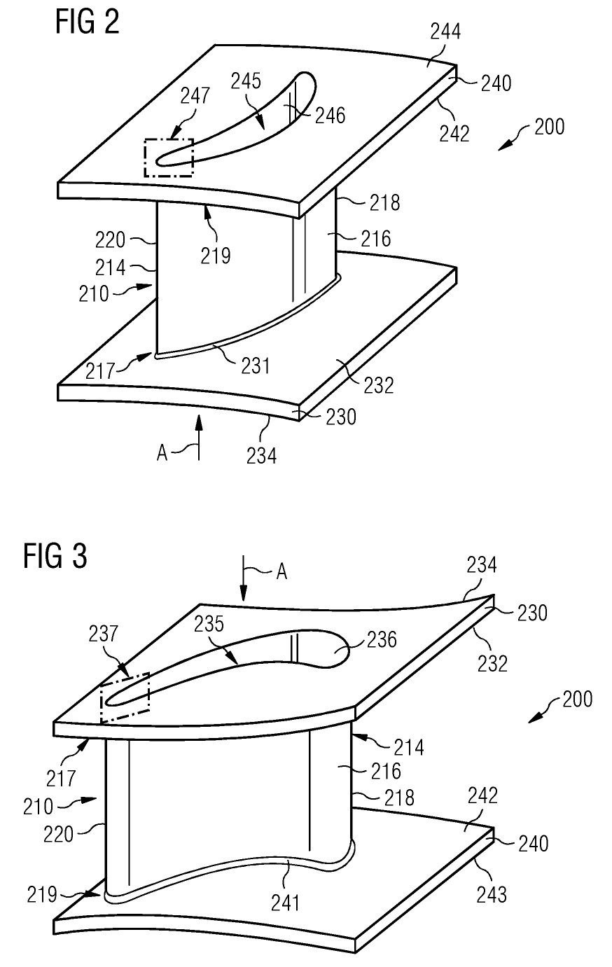

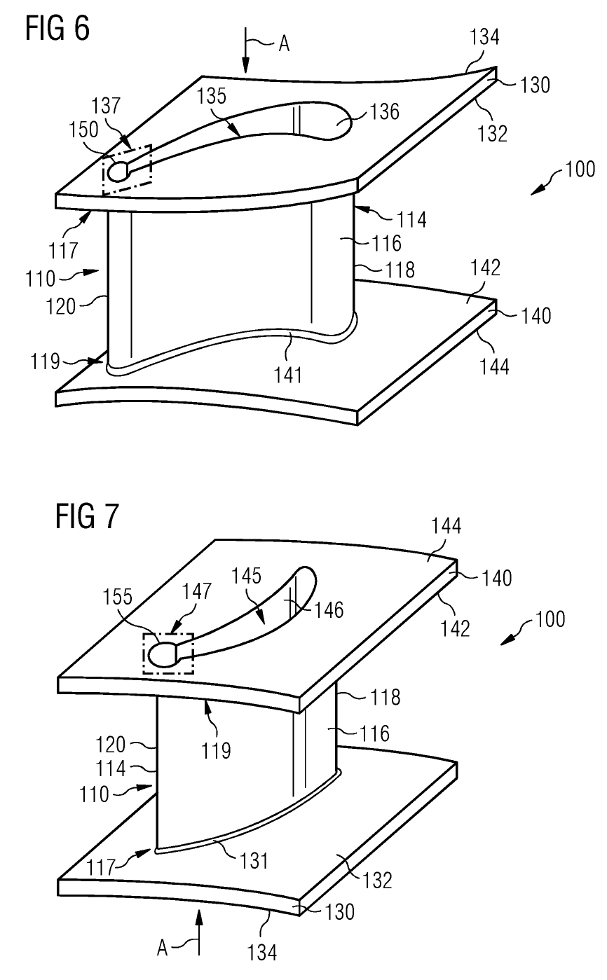

Hereinafter the present technique has been explained further with reference to FIGS. 6 to 11. FIG. 6 schematically represents a turbomachine component 100 having an aerofoil 110 and may be understood in comparison to FIG. 3 which schematically represented similar view of a conventionally known vane 200 as described hereinabove. FIG. 7 schematically represents the turbomachine component 100 oriented as depicted by arrow A in FIG. 6 and may be understood in comparison to FIG. 2 which schematically represented similar view of the conventionally known vane 200 as described hereinabove. It may be noted that although in the description hereinafter the turbomachine component 100 has been shown to be a turbine vane 100, it is well within the scope of the present technique that the turbomachine component 100 is a turbine blade.

As shown in FIGS. 6 and 7, the turbomachine component 100 having the aerofoil 110, particularly a blade or a vane for a gas turbine engine 10 (shown in FIG. 1), has the present technique implemented in it. The turbomachine component 100, hereinafter also referred to as the vane 100 has the aerofoil 110. The aerofoil 110 has a suction side wall 116 and a pressure side wall 114 that together define an aerofoil cavity. The suction side wall 116 and the pressure side wall 114 meet at a leading edge 118 and a trailing edge 120.

The vane 100 further has a circumferentially extending first platform 130 wherefrom the aerofoil 110 extends radially. The first platform 130 may be understood as the inner platform 230 described hereinabove with reference to FIGS. 2 and 3. The first platform 130 includes a first-platform cavity 135, hereinafter also referred to as the cavity 135. The cavity 135 is continuous with the aerofoil cavity. The shape of the cavity 135 corresponds substantially, i.e. has a substantially similar shape, to a shape of the aerofoil 110.

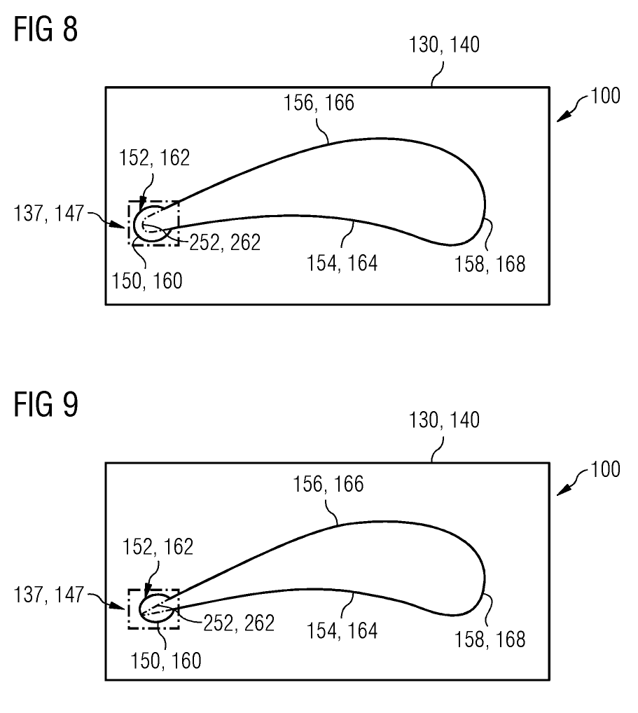

As shown in FIGS. 8 and 9 in combination with FIGS. 6 and 7, the cavity 135 has a leading-edge end 158 corresponding to the leading edge 118 of the aerofoil 110 and a trailing-edge end 152 corresponding to the trailing edge 112 of the aerofoil 110. In other words, the leading-edge end 158 is the end of the cavity 135 that is substantially or completely positioned below the leading edge 118 of the aerofoil 110 when viewed in the radial direction with respect to the rotational axis 20. Similarly, in other words, the trailing-edge end 152 is the end of the cavity 135 that is substantially or completely positioned below the trailing edge 112 of the aerofoil 110 when viewed in the radial direction with respect to the rotational axis 20. Similarly, the side 156 of the cavity 135 corresponds to the side 116 of the aerofoil 110, and the side 154 of the cavity 135 corresponds to the side 114 of the aerofoil 110.

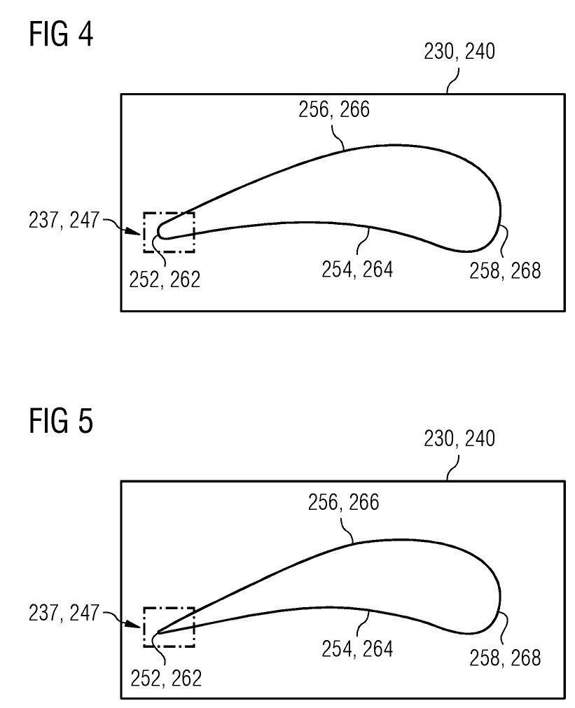

According to the present technique and as depicted in FIGS. 6 to 9 in comparison with FIGS. 2 to 5, in the turbomachine component 100, the cavity 135 at the trailing-edge end 152 forms a protuberance 150 within the first platform 130. The protuberance 150 may be understood as a bulge in the cavity 135 at the trailing-edge end 152 of the cavity 135. To explain further it may be said that the cavity 135 at the trailing-edge end 152 of the cavity 135 protrudes into the first platform 130 as compared to a conventionally known vane 200 described in FIGS. 2 to 5, or to explain further, the protuberance 150 mean an extension or modification of the trailing-edge end 152 of the cavity 135 with respect to the conventionally known trailing edge end 252 and generally in form of a rounded expanse. In an exemplary embodiment, and as depicted in FIGS. 8 and 9, the protuberance 150 is bulbous or bulb-like in shape. In another exemplary embodiment (not shown) the protuberance 150 may be elliptical in shape. In general moving from the leading-edge end 158 through the sides 156 and 154 the wall 136 of the cavity 135 traces the shape of the aerofoil 110 but moves outward, in comparison to the shape of the aerofoil 110, making a bulge in the cavity 135 in and around the trailing-edge end 152 to form the protuberance 150.

In an exemplary embodiment of the turbomachine component 100, as depicted in FIG. 8, a contour of the protuberance 150 viewed radially encompasses or completely encloses a 2-dimensional projection of the trailing edge 120 of the aerofoil 110. The 2-dimensional projection of the trailing edge 120 of the aerofoil 110 can be understood as emanating from a surface of the first platform 130 i.e. the aerofoil-side surface 132 of the first platform 130, wherefrom the aerofoil 110 extends radially. As shown in FIG. 8, the 2-dimensional projection of the trailing edge 120 of the aerofoil 110 will be same as the trailing-edge end 252 of a conventionally known vane 200.

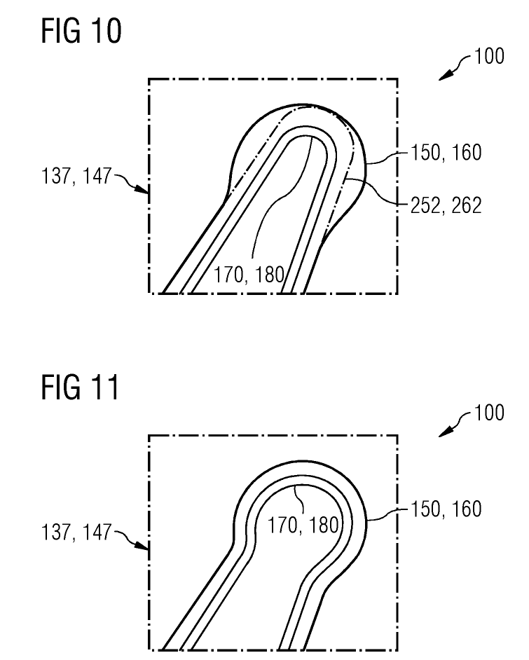

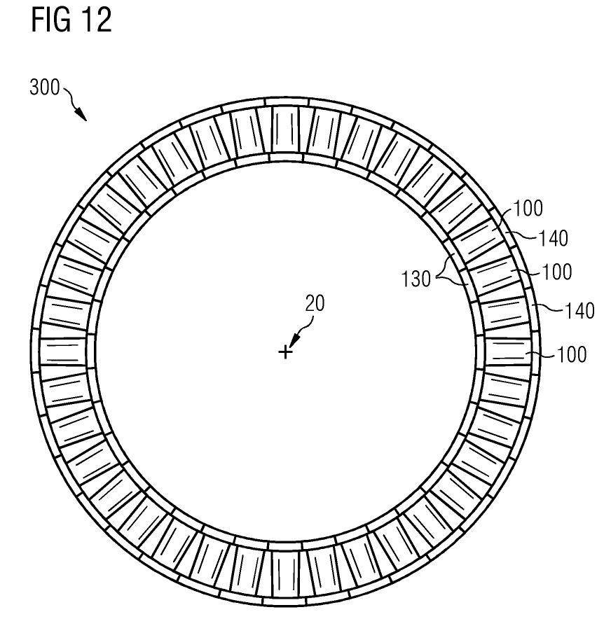

Referring to FIG. 10 another exemplary embodiment of turbomachine 100 component is presented. The turbomachine component 100 further includes a first cooling fluid tube 170. As shown in FIG. 10, at least a part of the first cooling fluid tube 170 is arranged within the cavity 135 and extends into the protuberance 150. As can be clearly seen from FIG. 10, there is more space at the trailing-edge end 152 of the cavity 135 to position the first cooling fluid tube 170 in the cavity 135 within the protuberance 150 as compared to the space at the trailing-edge end 252 of the conventionally known vane 200. In another embodiment of the turbomachine component 100, as depicted in FIG. 11, the first cooling fluid tube 170 is arranged such that it corresponds to a shape of the protuberance 150, and thus is able to cool more area of the cavity wall 136 as compared to the conventionally known vane 200. The first cooling fluid tube 170 is any tubing or tubular structure that is conventionally used for circulating or ejecting coolant in a gas turbine.

Referring again to FIGS. 6 to 11, as depicted in FIGS. 6 and 7, the vane 100 further has a circumferentially extending second platform 140 whereto the aerofoil 110 radially extends to. The second platform 140 may be understood as the outer platform 240 described hereinabove with reference to FIGS. 2 and 3. The second platform 140 includes a second-platform cavity 145, hereinafter also referred to as the cavity 145. The cavity 145 is continuous with the aerofoil cavity. The shape of the cavity 145 corresponds substantially, i.e. has a substantially similar shape, to a shape of the aerofoil 110.

As shown in FIGS. 8 and 9 in combination with FIGS. 6 and 7, the cavity 145 has a leading-edge end 168 corresponding to the leading edge 118 of the aerofoil 110 and a trailing-edge end 162 corresponding to the trailing edge 112 of the aerofoil 110. In other words, the leading-edge end 168 is the end of the cavity 145 that is substantially or completely positioned below the leading edge 118 of the aerofoil 110 when viewed in the radial direction with respect to the rotational axis 20. Similarly, in other words, the trailing-edge end 162 is the end of the cavity 145 that is substantially or completely positioned below the trailing edge 112 of the aerofoil 110 when viewed in the radial direction with respect to the rotational axis 20. Similarly, the side 166 of the cavity 145 corresponds to the side 116 of the aerofoil 110, and the side 164 of the cavity 145 corresponds to the side 114 of the aerofoil 110.

According to the present technique and as depicted in FIGS. 6 to 9 in comparison with FIGS. 2 to 5, in the turbomachine component 100, the cavity 145 at the trailing-edge end 162 forms an additional protuberance 160 within the second platform 140. The additional protuberance 160 may be understood as a bulge in the cavity 145 at the trailing-edge end 162 of the cavity 145. To explain further it may be said that the cavity 145 at the trailing-edge end 162 of the cavity 145 protrudes into the second platform 140 as compared to a conventionally known vane 200 described in FIGS. 2 to 5, or to explain further, the additional protuberance 160 means an extension or modification of the trailing-edge end 162 of the cavity 145 with respect to the conventionally known trailing edge end 252 and generally in form of a rounded expanse. In an exemplary embodiment, and as depicted in FIGS. 8 and 9, the additional protuberance 160 is bulbous or bulb-like in shape. In another exemplary embodiment (not shown) the additional protuberance 160 may be elliptical in shape. In general moving from the leading-edge end 168 through the sides 166 and 164 the wall 146 of the cavity 145 traces the shape of the aerofoil 110 but moves outward, in comparison to the shape of the aerofoil 110, making a bulge in the cavity 145 in and around the trailing-edge end 162 to form the additional protuberance 160.

In an exemplary embodiment of the turbomachine component 100, as depicted in FIG. 8, a contour of the additional protuberance 160 viewed radially encompasses or completely encloses a 2-dimensional projection of the trailing edge 120 of the aerofoil 110. The 2-dimensional projection of the trailing edge 120 of the aerofoil 110 can be understood as emanating from a surface of the second platform 140 i.e. the aerofoil-side surface 142 of the second platform 140, whereto the aerofoil 110 radially extends. As shown in FIG. 8, the 2-dimensional projection of the trailing edge 120 of the aerofoil 110 will be same as the trailing-edge end 252 of a conventionally known vane 200.

Referring to FIG. 10 another exemplary embodiment of turbomachine 100 component is presented. The turbomachine component 100 further includes a second cooling fluid tube 180. As shown in FIG. 10, at least a part of the second cooling fluid tube 180 is arranged within the cavity 145 and extends into the additional protuberance 160. As can be clearly seen from FIG. 10, there is more space at the trailing-edge end 162 of the cavity 145 to position the second cooling fluid tube 180 in the cavity 145 within the additional protuberance 160 as compared to the space at the trailing-edge end 252 of the conventionally known vane 200. In another embodiment of the turbomachine component 100, as depicted in FIG. 11, the second cooling fluid tube 180 is arranged such that it corresponds to a shape of the additional protuberance 160, and thus is able to cool more area of the cavity wall 146 as compared to the conventionally known vane 200. The second cooling fluid tube 180 is any tubing or tubular structure that is conventionally used for circulating or ejecting coolant in a gas turbine.

FIG. 12 schematically represents an array 300 of turbomachine components 100, 200, wherein the array 300 includes a plurality of turbomachine components 100, 200 arranged contiguously wherein at least one of the turbomachine components 100, 200 in the array 300 is the turbomachine component 100 as described hereinabove with reference to FIGS. 6 to 11. The array 300 is formed by arranging or positioning conventionally known turbomachine components 200 with at least one turbomachine component 100 of the present technique. In an exemplary embodiment, the array 300 is completely formed by arranging or positioning by a plurality of turbomachine component 100 of the present technique.

The array 300 is formed by attaching first 130 and second 140 platforms of one turbomachine component 100 to respective first 130 and second platforms 140 of the next turbomachine component 100 and/or the conventionally known vane 200. The array 300 is installed in a circular array of the turbomachine components 100 as in FIG. 12. Each platform 130, 140 contacts two adjacent platforms 130, 140, respectively, along opposite sides and in a circumferential direction with respect to the rotational axis 20. This results in circular array 300 of adjacent first platform 130 and second platform 140.

In the present disclosure, orientation terms such as “radial”, “inner”, “outer”, “circumferential”, “beneath” “below” and the like are to be taken relative to a turbine axis i.e. the rotational axis 20. “Inner” means radially inner, or closer to the rotational axis 20.

While the present technique has been described in detail with reference to certain embodiments, it should be appreciated that the present technique is not limited to those precise embodiments. Rather, in view of the present disclosure which describes exemplary modes for practicing the invention, many modifications and variations would present themselves, to those skilled in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

1. A turbomachine component having an aerofoil, the turbomachine component comprising:
a suction side wall of the aerofoil and a pressure side wall of the aerofoil bordering an aerofoil cavity, wherein the suction side wall and the pressure side wall meet at a leading edge and a trailing edge;
a circumferentially extending first platform wherefrom the aerofoil extends radially, the first platform comprising a first-platform cavity corresponding to a shape of the aerofoil, and wherein the first-platform cavity is continuous with the aerofoil cavity, the first-platform cavity comprising a leading-edge end corresponding to the leading edge of the aerofoil and a trailing-edge end corresponding to the trailing edge of the aerofoil,
wherein the first-platform cavity at the trailing-edge end forms a protuberance within the first platform.

2. The turbomachine component according to claim 1,
wherein a contour of the protuberance viewed radially encompasses a 2-dimensional projection of the trailing edge of the aerofoil, the 2-dimensional projection of the trailing edge of the aerofoil emanating from a surface of the first platform wherefrom the aerofoil extends radially.

3. The turbomachine component according to claim 1,
wherein the protuberance is bulbous in shape.

4. The turbomachine component according to claim 1,
wherein the protuberance is elliptical in shape.

5. The turbomachine component according to claim 1, further comprising:
a first cooling fluid tube wherein at least a part of the first cooling fluid tube is arranged within the first platform cavity and extends into the protuberance.

6. The turbomachine component according to claim 5,
wherein the first cooling fluid tube is arranged such that a layout of the first cooling fluid tube corresponds to a shape of the protuberance.

7. The turbomachine component according to claim 1, further comprising:
a circumferentially extending second platform, wherein the aerofoil radially extending from the first platform radially extends into the second platform, the second platform comprising a second-platform cavity corresponding to the shape of the aerofoil, and wherein the second-platform cavity is continuous with the aerofoil cavity, the second-platform cavity comprising a leading-edge end corresponding to the leading edge of the aerofoil and a trailing-edge end corresponding to the trailing edge of the aerofoil, and wherein the second-platform cavity at the trailing-edge end forms an additional protuberance within the second platform.

8. The turbomachine component according to claim 7,
wherein a contour of the additional protuberance viewed radially encompasses a 2-dimensional projection of the trailing edge of the aerofoil, the 2-dimensional projection of the trailing edge of the aerofoil emanating from a surface of the second platform whereto the aerofoil extends radially.

9. The turbomachine component according to claim 7,
wherein the additional protuberance is bulbous in shape.

10. The turbomachine component according to claim 7,
wherein the additional protuberance is elliptical in shape.

11. The turbomachine component according claim 7, further comprising:
a second cooling fluid tube wherein at least a part of the second cooling fluid tube is arranged within the second platform cavity and extends into the additional protuberance.

12. The turbomachine component according to claim 11,
wherein the second cooling fluid tube is arranged such that a layout of the second cooling fluid tube corresponds to a shape of the additional protuberance.

13. An array of turbomachine components, wherein the array comprises:
a plurality of turbomachine components arranged contiguously wherein at least one of the turbomachine components in the array is according to claim 1.

14. The turbomachine component according to claim 1,
wherein the turbomachine component comprises a blade or a vane for a gas turbine engine.
